(19) United States
(12) Patent Application Publication
(10) Pub. No.: US 2006/0026039 A1
(43) Pub. Date: Feb. 2, 2006

(54) Method and system for provision of secure medical information to remote locations

(75) Inventors: Richard Shoenhair, Cupertino, CA (US); Kenneth Toren, Los Gatos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: REDmedic, Inc., San Jose, CA (US)

(21) Appl. No.: 10/900,552

(22) Filed: Jul. 27, 2004

(51) Int. Cl. G06F 19/00

(52) U.S. Cl. 705/3; 707/9

(57) ABSTRACT

A method for enabling remote self service retrieval of medical information for an individual is disclosed. The method includes steps of storing personal information and medical information in different databases. Different encryption keys are used to isolate the types of information. Upon receipt of a request from a health care provider, the authenticity of the request is verified. At a central location, using the identification of the individual, the medical information for that individual is retrieved and provided to the health care entity treating the individual.

### BACKGROUND OF THE INVENTION

This invention relates to a system and processes for distribution of medical information-for individuals in cases of emergency or urgent medical situations. Such medical information is often referred to as “protected health information” and is referred to herein sometimes as PHI.

Healthcare providers in emergency situations have an urgent need to obtain relevant medical information about patients appearing in their facilities. Frequently those facilities are not the patient's usual facility where the patient's medical records typically are retained. As a result, records on the individual are not generally available at the facility where the patient is being treated for the urgent medical condition. When this happens, the caregiver must make the best judgment possible given limited information and the circumstances at the time. The importance of obtaining the information quickly is greatly increased because in an emergency situation, care given in the first hour of treatment is critical to a positive outcome. Usually the caregiver does not need all of the patient's medical records, but would benefit from a targeted summary of the patient's medical history and health regimen. Such a targeted summary can include allergies to common medications, prescriptions being taken b the patient at the time, particular conditions previously diagnosed, etc.

The United States Health Insurance Protection and Accessibility Act (HIPAA) requires Protected Health Information (PHI) to remain private to the individual health care consumer. The privacy requirements in HIPAA impose strict rules addressing the appropriate safe storage of PHI, as well as requiring security involving accidental or deliberate exposure of electronic formats of PHI. Any electronic transfer of information requires authentication of the recipient. In addition PHI must be maintained in a secure fashion prior to any attempt to distribute the information.

Accurate delivery of summary data regarding crucial aspects of the patient's medical history necessary for urgent care also benefits by the elimination of extraneous information not needed for diagnosis or treatment within the emergency room or urgent care facility. What is needed is a system by which a patient's medical records, or at least the crucial aspects thereof involved in the treatment of urgent conditions, is available to locations remote from the patient's usual treatment facility.

### BRIEF SUMMARY OF THE INVENTION

The techniques of this invention enable rapid delivery of critical information in a summarized form to an urgent care or emergency room caregiver Non-essential information is removed from the overall medical record provided to the caregiver. This assists a treating physician in providing the appropriate care in the first hour of treatment critical to a positive outcome. In addition, security issues with regard to the dissemination of medical records among facilities are carefully controlled in a manner which complies with statutory and regulatory requirements. To enhance security, the system of this invention segregates the storage of information both in content and in location.

Furthermore, under HIPAA the appropriate care of the individual is paramount in allowing flexibility to act on behalf of the individual. The system of this invention includes an electronic process to analyze the patient's health information and to include medically significant entries into the summary report.. The system also addresses the privacy and security issues regarding the health information it maintains on behalf of the patient, yet provides emergency room personnel with rapid delivery of medical information.

This rapid and accurate delivery of health information summary data depends on elimination of intervening manual processes. The system according to this invention allows the individual healthcare consumer to interact with pertinent medical information in advance of its use in an urgent context, and allows emergency room personnel to use the system via the Internet, telephone and facsimile networks with a completely self-service mode for all transactions. Automatic mechanisms perform the information transportation tasks. Data security is maintained by utilizing appropriate delivery mechanisms based on requester authentication results.

In addition, the system of this invention includes an electronic process allowing incoming requests for a patient's medical information to be delivered only to pre-authenticated medical care facilities. It also allows identification of the requesting facility electronically without use of special authentication devices or personally entered identification codes. This enables information to be obtained by the healthcare facility rapidly and securely without compromising privacy or security regulations.

In one embodiment a method for enabling remote retrieval of medical information for an individual includes steps of storing personal information in a first set of databases and storing medical information in a second set of databases. Different encryption keys are used to isolate the personal information and the medical information corresponding to that personal information. This segmentation into small, well protected compartments provides additional security for the medical information. Upon receipt of a request from a health care provider for medical information for the individual, the authenticity of the request is verified by confirming identification of the health care provider and confirming identification of the individual. Then at a central location, using the identification of the individual, the medical information for that individual is retrieved and provided to the health care entity treating the individual.

### BRIEF DESCRIPTION OF THE DRAWINGS

FIG. 1 is a diagram illustrating data acquisition and report generation;

FIG. 2 is a diagram illustrating segregation of information, databases and encryption keys;

FIG. 3 is a diagram illustrating retrieval of information from an information depository;

FIG. 4 is a flow chart illustrating typical procedures for retrieval of medical information; and

FIG. 5 is a diagram illustrating sample contents for a portion of a medication database.

### DETAILED DESCRIPTION OF THE INVENTION

The system of this invention relies upon having a patient's medical information in an electronic format. If the information is not already available in an appropriate electronic format or if the existing records cannot be converted to such a format, the medical information must be collected. The system of this invention enables the service members (the service members are sometimes termed “REDmedic members” herein to refer to the entity providing the service), their physicians, support personnel, and institutions involved with healthcare to input information into a medical history database. In addition the prospective patient, referred to herein sometimes as a “member” of the service, may add additional information regarding needed medical care issues. For example, additional information may include a living will, organ donor information, a baseline electrocardiogram and other documents.

Electronic medical information is often exchanged using well known HL7 data encoding. Information from medical institutions may be obtained electronically by interpreting HL7 communications among hospitals, insurance companies and pharmacies. Using the system of this invention, the patient is permitted (in compliance with HIPAA regulations) to direct these institutions to share their medical information with designated third parties. Once enabled, the HL7 data normally used for billing and claims transactions can also be used for record creation activities in conjunction with the system of this invention.

The coding used in HL7 data includes IDC9 codes for diagnostic information, CPT4 codes for treatment information, and FDA data for medications. Each portion of the information taken individually only infers to a particular medical situation. Taken together, however, the patient's record may be precisely updated. This information can include treatments and medications of all types, even those not officially approved for certain conditions.

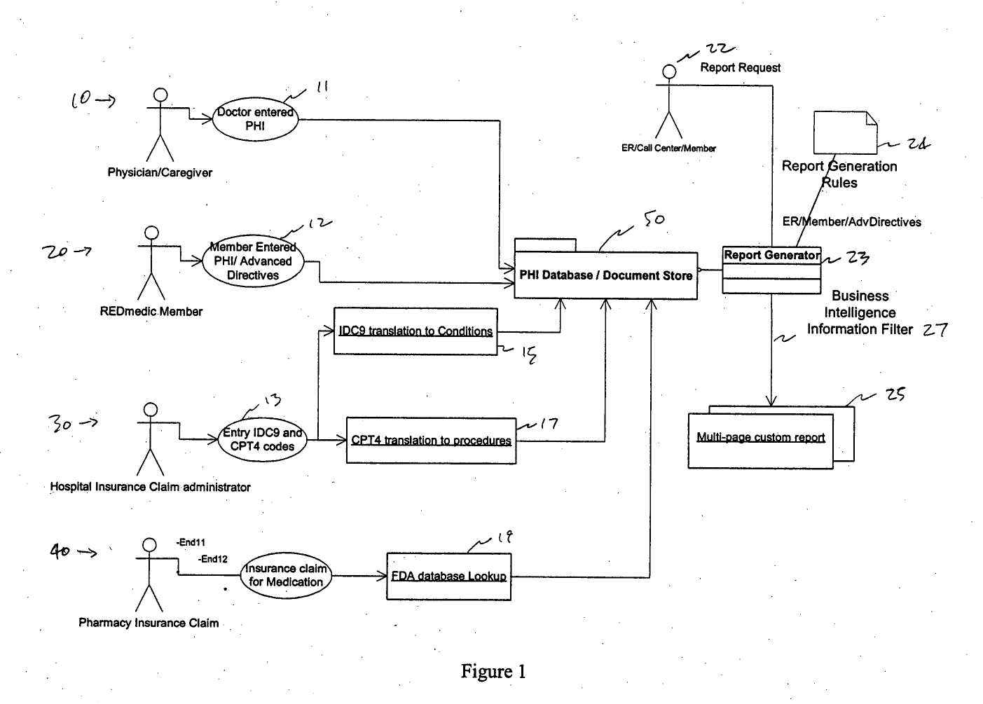

FIG. 1 illustrates the process of creating an intelligent medical summary report from various information sources. Shown in FIG. 1 are representations of a series of sources of information for the patient's electronic medical records. These include a physician/caregiver 10, the prospective patient or REDmedic member himself 20, a hospital or other entity insurance claims administrator 30, and a pharmacy or other pharmaceutical-related insurance claim 40. As shown by the diagram, each of these individuals or entities can provide information into the patient's medical history database and document storage 50. This information can be entered by the physician or caregiver providing the Protected Health Information 11, and by the member 20 entering such PHI information, as well as advance directives such as living wills, do not resuscitate orders, etc., 12. In addition, the hospital insurance claims administration office may provide IDC9 and CPT4 codes representative of information about the member's recent clinical treatments. These codes 13 can be translated into conditions 15 and into procedures 17, also for entry in the PHI database 50. Finally, information about medication can be provided to the system by using a lookup table containing information about the FDA-approved medications 19.

As mentioned above, there are three code translators involved in the process shown in FIG. 1. The receipt of HL7 information from the various institutions involved with treatment of a single medical incident is asynchronous. Information is pooled within the PHI database and progressive best judgments are included in the record. Certification of the information and inclusion into the record is always the task of the member or the member's physician. Inclusion into the summary report is tentative until verified personally.

Dates recorded for each HL7 transaction are a primary key used to associate different information fragments into a comprehensive report summary. Secondary analysis using the standards established by the FDA, AMA and CMS (HHS) validates the data association into PHI entries. Clearly not all medical information is significant for emergency treatment. A single incident of a common illnesses would clutter the summary report intended for emergency caregivers. The report generator 23 is rules driven 24 to include into the report only significant data. This mechanism allows for a variety of reports based on different rule sets. The member may view all information and view any standard report. The report generator has rule sets for: emergency caregivers, a member summary report, a medical specialist (i.e. Pulmonary, Cardiologist etc.), and for paramedics. Each of these documents has significance in different applications. Using the rules sets, the report generator selectively includes these documents into the resulting reports.

As shown by FIG. 1, once the information is in the database and stored, requests may be submitted to that database to generate reports using various parameters. The report will typically be requested by an emergency room physician, assistant, or emergency medical technician (EMT) via the Internet, either electronically or personally via the company call center, or even by the member himself, all as represented by icon 22. The report request itself, together with report generation rules, are provided to the PHI database 50, together with any appropriate directives from the member or the urgent care giver, to generate a report. The resulting report 25 is prepared in accordance with these requests, and may be filtered 27 to present only the information of most importance in the particular situation. The goal of the system, as suggested above, is to present the caregiver with a short report that contains the information of utmost value for the particular emergency or urgent situation involved.

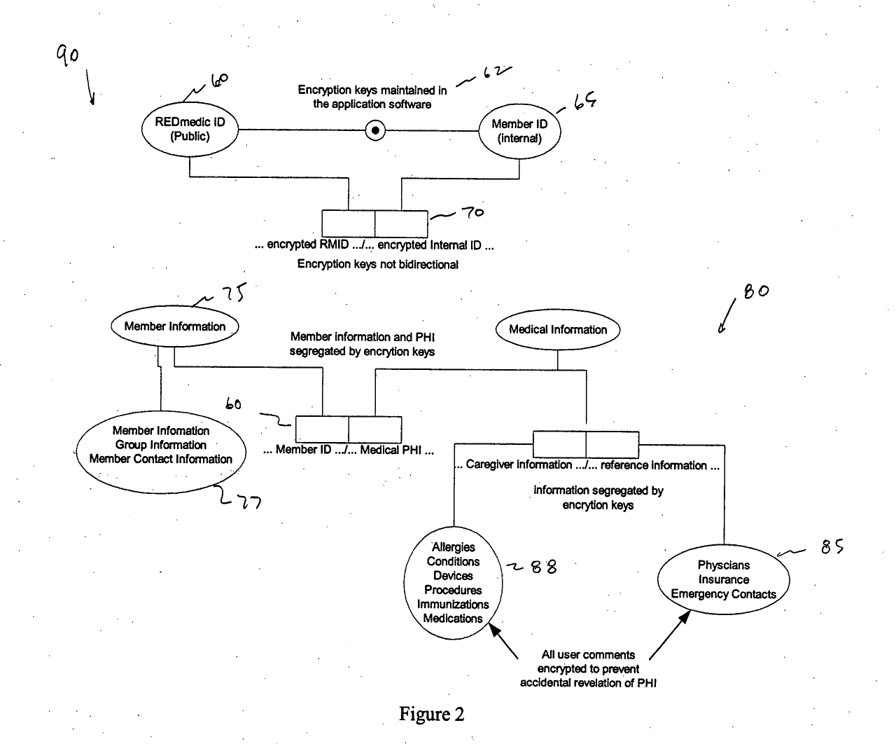

As also mentioned above, various federal and state statutes and regulations carefully control access to a patient's medical information. The techniques by which this is achieved in the system herein are explained in conjunction with FIG. 2. One basic principle of information protection within the system data storage 50 relies on the disassociation of information classes into separate tables, maintaining multiple encryption keys, and periodically changing the encryption keys. Each part of this information is stored in separate tables to assist in preventing its accidental disclosure. FIG. 2 illustrates the separation of data with separate ovals being used to designate the separate tables used to store each type of information.

The public access code is represented by the REDmedic ID 60. This is an identification number issued to the member (prospective patient) at the time the individual registers for the service. The number is printed on the membership card. Also included on the card is other REDmedic information presented to caregivers to identify the member. The first level of translation/encryption 62 occurs when converting the REDmedic ID into the internal member ID 65. The combination of the internal and external identifications 70 provide a secure and unique identification field not publicly accessible. This combination is used within the system for the retrieval of medical information. Thus even someone who acquires the member's identification card and acquires access to the computers and storage systems at the location where the medical information is stored will not be able to retrieve the medical information for that individual. Encryption and decryption is handled at the application level with multiple rotating keys not held in the same database or application code locations.

The member's name is stored, along with other identification including address and date of birth as member information 75. This may also include information 77 such as contact information and information about a “group” such as an employer. Care to separate this personal information from the protected health information 80 (on the right hand side of FIG. 2) is essential to prevent any pattern matching mechanism from decoding the links within the database. A similar mechanism to that which separates the REDmedic ID 60 from the Internal ID 65 is used to separate member information 90 (on the left side of FIG. 2) from that member's protected health information 80.

Often a member's social security number (SSN) is used as a member's ID for health insurance policies or a doctor's patient ID. The database is segregated again between data 85 and data 88 to prevent any association between policy and patient numbers based on the member SSN. Of course data 88 is the data that typically will be of greatest value to a treating physician in an emergency situation.

Encryption keys are changed on a schedule, and in the event of unauthorized access to the system, to prevent compromise of protected health information even if a particular encryption key is broken. Different keys are used for each table. Therefore, even if a single table is compromised, the different keys prevent the same information from being used to decrypt the other tables. The changing of keys assures that even within a single table, the encryption is not constant.

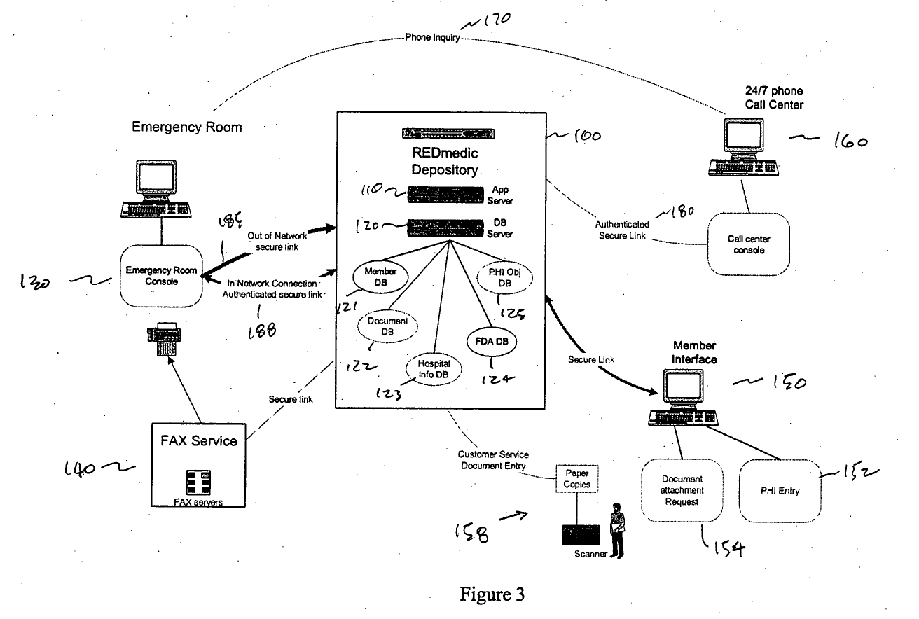

FIG. 3 is a diagram which illustrates the relationships among various accesses to the overall patient information maintained in a system according to this invention. The central rectangle in FIG. 3 contains all of the information discussed above in conjunction with FIGS. 1 and 2. Shown in block form in FIG. 3 are the application server 110 and the database server 120. The application server executes particular applications, for example the application software typically embodying a system according to this invention, while the database server 120 maintains the databases which contain the information as shown in FIGS. 1 and 2. For example, database server 120 includes the member database 121 and a document database 122 containing scanned information from paper copies about the patient's medical history. Hospital information is stored in database 123, while information about FDA-approved medications is found in database 124. The patient's protected health information is stored in database 125. Subject to the member's permission, data from each of these databases can be retrieved by the database server and provided to an application being executed as shown around the exterior of block 100.

The access points to the information depository 100 include an emergency room console 130, facsimile service 140, and a member interface 150. A call center 160 described in further detail below may also be implemented.

In operation, an emergency room inquiry by telephone 170 may be made to the call center 160. The call center then communicates with the depository 100 over an authenticated secure link 180. Link 180 will provide permission for the depository 100 to communicate with the emergency room console 130. This communication can either take place over an out-of-network secure link 185 or an in-network connection which is electronically authenticated 188.

Member interface 150, typically a personal computer with an internet connection, allows a member to communicate with the depository 100 regarding that member's protected health information 152. It also permits the member to provide scanned information about medical conditions by either sending scanned electronic copies of particular documents, or providing such documents to a third party which scans them and forwards the information electronically to the depository 100. The scanning and paper document entry is shown at Station 158 in FIG. 3.

FIG. 3 illustrates two self-service access points to the system. Working together the REDmedic member indirectly interacts with a future caregiver through the system. There are over 4000 medical facilities in the United States that maintain emergency or trauma centers. Each of these facilities has trained medical staff skilled at medical treatment for emergency and urgent cases. Assisting the medical staff is support staff charged with dealing with admittance, insurance and legal security of the patients entering the facility. All emergency facilities are governed and licensed by state agencies and most are Medicare qualified facilities. Any medical care facility providing emergency services and all the personnel in any associated emergency departments are covered by HIPAA. The system herein maintains a database of all these facilities as one source for assisting in verification of any inquiry requesting a patient's information.

The authentication architecture described herein determines the trustworthiness of the requester. Hospitals may have direct or indirect access to the members PHI and attached documents. In-network hospitals have designated consoles with security certificates installed. Upon establishing a secure Internet connection with REDmedic 100, the hospital may request full information about incoming patients directly on screen, or printed on attached printers.

Hospitals that do not have a direct in-network relationship to REDmedic 100 may also receive information directly from REDmedic 100 via the Internet. REDmedic maintains a database of all hospital emergency departments in database 123 containing critical communication information. Delivery of medical information to these hospitals can be accomplished through a secure facsimile communication 140. Just as secure consoles are identified for in-network hospitals, facsimile machine phone numbers are maintained for all hospitals. PHI information delivery is constrained to these specific locations. Thus, to receive a patient's medical information, the requesting party must be situated at an appropriate terminal.

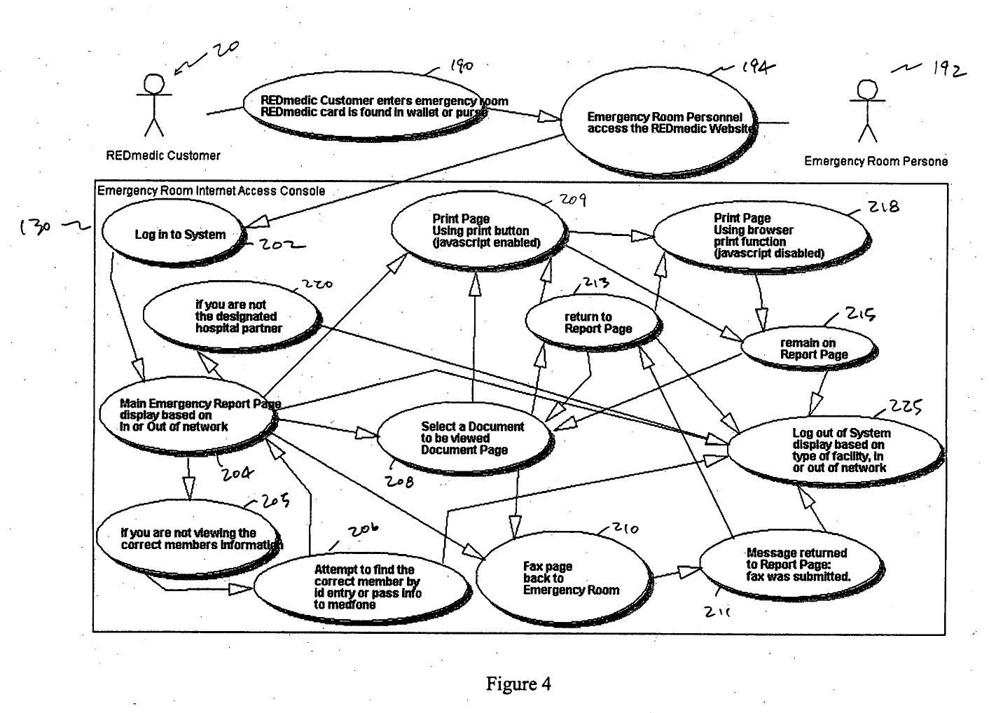

FIG. 4 is a diagram illustrating process steps carried out by a system according to a preferred embodiment of this invention. A typical system is as described in FIGS. 1, 2 and 3 above. The steps shown in FIG. 4 illustrate how a particular patient 20 and emergency room personnel 192 with access to an internet console, for example shown in FIG. 3, may use the system in the context of an emergency room visit. As shown at the top of FIG. 4, the process begins with the individual 20 entering the emergency room and either providing a card to the emergency room, or the emergency room discovering the card in the wallet or purse, or being informed the patient is a REDmedic customer. This step is illustrated as step 190. At that point an appropriate individual in the emergency room 192 accesses the REDmedic website as shown by step 194. The initial event which occurs is that the individual logs into the system at step 202. In response, a report page is displayed based on whether the log-in is from within or out of the network, as shown in step 204. If at the log-in, the correct patient information is not being viewed 205, then an attempt is made to find the correct member by telephone or by re-entry of the identification information at step 206.

Once the correct member identification is provided, then a document can be selected at step 208 for presentation on the emergency room console. This will typically be the information important for emergency or urgent care of the patient. In the event that the system reached this point from within the network, the page can then be printed in a conventional manner as shown by step 209. On the other hand, if the document is being selected by a system out of the network, then the page is faxed to the emergency room as shown by step 210. In response to this, a message is returned to report that the page was faxed at step 211, and the system returns to the report page at step 213.

If the page is printed as shown by step 209, then after printing the system continues to display the report page as shown in step 215. From this location additional documents may be selected and printed as shown by the loop of steps 208, 209 and 215. An alternative printing technique is shown by step 218, which is employed if Javascript is disabled.

As also shown, in step 204, if the incorrect hospital has been selected, as shown by step 220, then a log-out from the system occurs at step 225. This same log-out occurs after the user has presented and printed the desired pages, or the desired pages have been faxed.

As discussed, in FIG. 4 the request and authentication process for delivery of protected health information is shown for emergency situations. At the core of the authentication process is satisfactory resolution of a challenge response dialog between the requester (the emergency department) and the REDmedic system. There are multiple levels of knowledge in an emergency or urgent care facility. For in-network hospitals, the challenge response occurs entirely electronically. For other hospitals, the challenge response uses information about the institution not generally known.

One example is that the federal government Medicare code identifies medical facilities that treat Medicare patients. Another is that all medical practitioners licensed to prescribe medications are licensed by the FDA. In addition, certain information such as facsimile numbers is known by the care personnel. The system of this invention uses one or more of these shared facts to ‘challenge’ the requester's identity. Once the response is correctly verified, the system transmits the protected health information to the requestor using a secure facsimile. Much of the medical information handled in medical care facilities is based on paper records. Receipt of such faxed information is normal and customary. All health records in these facilities are handled under HIPAA regulations and can be presumed secure.

Table 1 is an example of the information maintained in the database for US Hospitals. This collection is unique and would not be found in any existing single source.

TABLE 1

| Hospital | |
|---|---|
| Attribute | Comments |
| Hospital ID | Internal unique tracking ID |
| Hospital Name | Obtained from the American Hospital |
| | Directory DB |
| Hospital Alias | Common nickname or abbreviation. For |
| | example, ‘Santa Clara Valley Medical |
| | Center’ is commonly referred to as |
| | ‘Valley Med’ |
| ED Phone Number | Voice line for problem resolution |
| ED FAX number | Primary FAX number for PHI delivery |
| ED FAX number | Back-up FAX for PHI delivery |
| alternate | |
| InNetwork, | Yes no |
| OutOfNetwork | |
| IP address range | InNetwork or Out of Network requester |
| | validation |
| Secure link | AHD_DB |
| method | |
| ED chief doctor | Possible challenge question for out |
| | of network |
| ED Nursing | Challenge question for out of network |
| Supervisor | |
| Unit Assistant/ | In Network or Out of Network problem |
| Reception Super- | resolution |
| visor | |
| Unit Assistant/ | In Network or Out of Network problem |
| Reception Super- | resolution |
| visor phone | |
| number | |
| Technical | Network issues for In Network Hospitals |
| Contact (CTO) | |
| CTO Phone Number | Contact Info |
| CTO email | Contact Info |
| Medicare Provider | Challenge question for out of network |
| Number: | |

Member access that member's records for data entry and edit functions is provided through a login name and password mechanism. Once access is established through secure Internet protocols, the member may then add, edit and hide information within his medical history. Easy access to categories of information is presented. In each category the member is guided to maintain the information using simple forms and reference data supplied by the site.

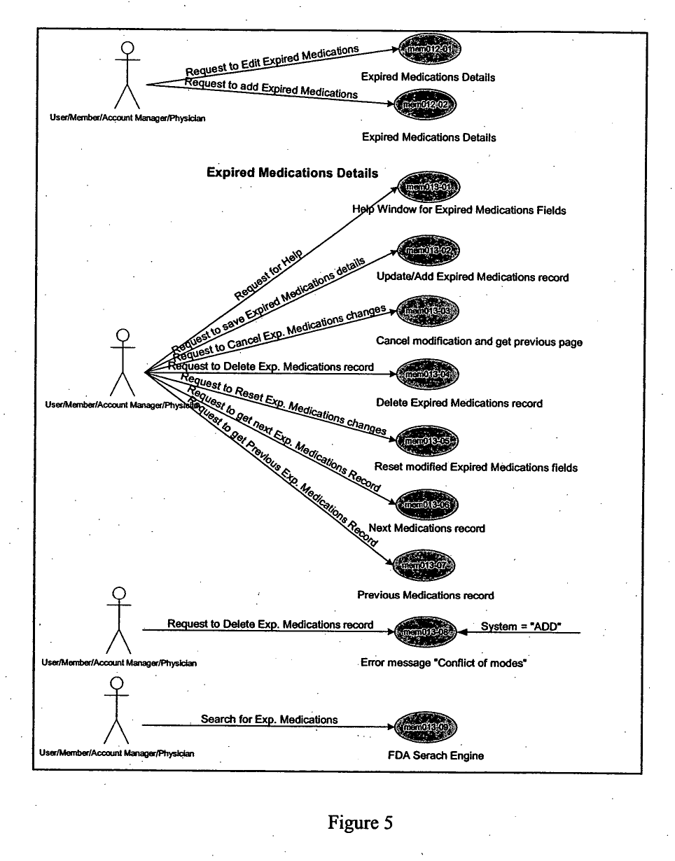

FIG. 5 is a diagram illustrating interactions which may be made by a member or health professional with the system relating to medications. As shown in the figure, individuals with access to the system can interact with the system to provide information regarding expired medications in numerous ways. These techniques include editing expired medications or adding information about them. Help may be requested as well as numerous other steps shown in FIG. 5. This figure is intended to provide one example of the capabilities of the system for interaction with the user.

The preceding description has assumed that the health information in the system is for an individual person. It will be appreciated that information about animals may also be stored and retrieved using the techniques described herein. In such circumstances a collar or tag affixed to the animal can be used to provide the appropriate identification information for access to the system.

In addition to the capabilities described herein, the HIPAA compliant code set for HL7 is defined for electronic communication between all organizations providing healthcare services. However, the HL7 coding system does not insure the requester has the authority to see a comprehensive PHI. Only the providers directly involved with treatment have the privilege to receive such information. Therefore additional well-known security mechanisms can be used to comply with the privacy rules for HIPAA. Of course, it should be appreciated that while the system of this invention has focused on the delivery of medical information in urgent situations, the system can also be used for “ordinary” non-urgent delivery of medical information to individual caregivers. Furthermore, as mentioned, information in place of, or in addition to health information, may also be made available using the system of this invention. For example, information about advance directives from the patient regarding his or her care may also be provided.

What is claimed is:

1. A method for enabling remote retrieval of medical information for an individual comprising:
storing personal information in a first set of databases;
storing medical information in a second set of databases;
providing different encryption keys to permit retrieval of the personal information and the medical information corresponding to that personal information;
upon receipt of a request from a health care provider for medical information for the individual, verifying authenticity of the request by confirming identification of the health care provider and confirming identification of the individual;
at a central location using the identification of the individual to retrieve the medical information for that individual; and
providing the medical information for the individual to the health care provider.

2. A method as in claim 1 wherein the step of verifying authenticity of the health care provider comprises verifying secure information provided by the health care provider to the central location.

3. A method as in claim 1 wherein the step of confirming identification of the individual comprises confirming an identification number possessed by that individual.

4. A method as in claim 1 wherein the step of providing the medical information comprises enabling the health care provider to retrieve it over the internet.

5. A method as in claim 1 wherein the step of providing the medical information comprises transmitting it by facsimile.

6. A method as in claim 1 wherein the step of storing medical information comprises at least enabling the individual to enter information and enabling an authorized provider of medical services to enter information.

7. A method as in claim 6 wherein the step of storing medical information further comprises:
receiving codes related to conditions and procedures from an insurance administrator; and
translating those codes into textual information for storage in the second set of databases.

8. A method as in claim 6 wherein the step of storing medical information further comprises:
receiving codes from an entity providing pharmaceuticals; and
translating those codes into textual information for storage in the second set of databases.

9. A method as in claim 1 wherein the step of using the identification of the individual to retrieve the medical information for that individual comprises preparing a summary report having emergency medical information specifically targeted for the caregiver treating that individual.

10. A method as in claim 1 wherein the individual receives a member number when enrolling to enable remote retrieval of medical information and a further identification number is assigned to the individual at the central location.

11. A method as in claim 1 wherein the medical information comprises an advance directive from the individual relating to medical care.

12. A method as in claim 1 wherein the individual comprises an animal.

13. A method for enabling remote retrieval of medical information for an individual comprising:
storing personal information in a first set of databases;
storing medical information provided by a health care provider in a second set of databases;
enabling the individual to access the first and second sets of databases to edit the stored medical information and the personal information and to store advanced directives regarding medical preferences of the individual;
providing different encryption keys to permit retrieval of the personal information and the medical information corresponding to that personal information;
upon receipt of a request from a health care provider for medical information for the individual, verifying authenticity of the request by confirming identification of the health care provider and confirming identification of the individual;
at a central location, using the identification of the individual to retrieve the medical information for that individual; and
providing the medical information for the individual to the health care provider.
